(19) United States
(12) Patent Application Publication
(10) Pub. No.: US 2022/0086048 A1
(43) Pub. Date: Mar. 17, 2022

(54) COMMUNICATION MANAGEMENT SYSTEM, MANAGEMENT SERVER, VPN SERVER, TERMINAL, COMMUNICATION MANAGEMENT METHOD, AND PROGRAM

(71) Applicant: NEC Corporation, Minato-ku, Tokyo (JP)

(72) Inventor: Akihisa KURASHIMA, Tokyo (JP)

(73) Assignee: NEC Corporation, Minato-ku, Tokyo (JP)

(21) Appl. No.: 17/422,323

(22) PCT Filed: Jan. 9, 2020
(86) PCT No.: PCT/JP2020/000404

§ 371 Date: Jul. 12, 2021

(30) Foreign Application Priority Data
Jan. 22, 2019 (JP) 2019-008312

(51) Int. Cl. H04L 41/0893; H04L 47/70

(52) U.S. Cl. CPC H04L 41/0893; H04L 47/70

(57) ABSTRACT

A processing unit (110) of a management server (10) transmits terminal authentication information to a terminal (50). When connecting to a first network via a second network (40) by VPN connection, the terminal (50) transmits the terminal authentication information to a VPN server (30) via a router (42). The VPN server (30) transmits the terminal authentication information received from the terminal (50), to the management server (10). Upon receiving the terminal authentication information from the VPN server (30), a management-side transmitting unit (130) reads out first address identification information associated with the terminal authentication information from a storage unit (120), and transmits a first address being identified by the first address identification information, to the VPN server (30).

### TECHNICAL FIELD

The present invention relates to a communication management system, a management server, a VPN server, a terminal, a communication management method, and a program.

### BACKGROUND ART

In recent years, mobile terminals are utilized in various situations. Thus, there are an increasing number of opportunities of hand-off of mobile terminals. For example, PTL 1 describes that, when a mobile terminal executes hand-off between a wireless connection via a mobile phone and a wireless connection via an NIC for LAN, a MAC address or an IP address allocated to the NIC for LAN and an authentication state shared between the mobile terminal and a server are transmitted to the server. By using this information, the server executes restoration of the authentication state after hand-off.

### CITATION LIST

### Patent Literature

[PTL 1] Japanese Patent Application Publication No. 2013-211781

### SUMMARY OF INVENTION

### Technical Problem

When a connection method of a terminal is switched from a state of direct connection to a certain network, to a state (VPN connection) of connection to the network via a virtual private network (VPN), it is highly possible that an address allocated to the mobile terminal changes. When the address changes, there is a possibility that communication is interrupted.

An example of a problem to be solved by the present invention is to prevent a change of an address of a terminal even when a destination of connection of the terminal is switched from a first network to VPN connection.

### Solution to Problem

According to the present invention, there is provided a communication management system being used together with a terminal being connectable to a first network, the communication management system including:

a VPN server for connecting the terminal to the first network by virtual private network (VPN) connection; and

a management server,

the management server including:

a processing unit that receives first address identification information capable of identifying a first address being an address allocated to the terminal in the first network, and correlates and stores, in a storage, the received first address identification information with terminal authentication information that authenticates the terminal; and

a management-side transmitting unit that reads out, upon receiving the terminal authentication information from the VPN server, the first address identification information associated with the terminal authentication information from the storage, and transmits the first address being identified by the first address identification information, to the VPN server,

the VPN server including:

an authentication information transfer unit that transmits the terminal authentication information of the terminal that requests the VPN connection, to the management server; and

a VPN connection unit that connects the terminal to the first network by the VPN connection by using an address identical to the first address transmitted from the management server.

According to the present invention, the above-described VPN server and the above-described management server are also provided.

According to the present invention, there is provided a communication management method using a VPN server and a management server, wherein

the VPN server and the management server are used together with a terminal being connectable to a first network,

the VPN server is configured to connect the terminal to the first network by virtual private network (VPN) connection,

the management server is configured to:

receive first address identification information capable of identifying a first address being an address allocated to the terminal in the first network, and correlate and store, in a storage, the received first address identification information with terminal authentication information that authenticates the terminal; and

read out, upon receiving the terminal authentication information from the VPN server, the first address identification information associated with the terminal authentication information from the storage, and transmit the first address that is identified by the first address identification information, to the VPN server, and

the VPN server is configured to:

transmit the terminal authentication information of the terminal that requests the VPN connection, to the management server; and

connect the terminal to the first network by the VPN connection by using an address identical to the first address transmitted from the management server.

According to the present invention, there is provided a communication management method using a computer,

the computer being configured to:

function as a VPN server being used together with a terminal being connectable to a first network, and a management server, the VPN server being configured to connect the terminal to the first network by virtual private network (VPN) connection;

transmit terminal authentication information of the terminal that requests the VPN connection, to the management server; and

connect the terminal to the first network by the VPN connection by using an address identical to a first address transmitted from the management server.

According to the present invention, there is provided a communication management method using a computer,

the computer being used together with a terminal being connectable to a first network, and a VPN server for connecting the terminal to the first network by virtual private network (VPN) connection,

the computer being configured to:

receive first address identification information capable of identifying a first address being an address allocated to the terminal in the first network, and correlate and store, in a storage, the received first address identification information with terminal authentication information that authenticates the terminal; and

read out, upon receiving the terminal authentication information from the VPN server, the first address identification information associated with the terminal authentication information from the storages, and transmit the first address being identified by the first address identification information, to the VPN server.

According to the present invention, there is provided a program being executable by a computer,

the program causing the computer to

function as a VPN server being used together with a terminal being connectable to a first network, and a management server, the VPN server being configured to connect the terminal to the first network by virtual private network (VPN) connection,

the program causing the computer to include:

a function of transmitting terminal authentication information of the terminal that requests the VPN connection, to the management server; and

a function of connecting the terminal to the first network by the VPN connection by using an address identical to a first address transmitted from the management server.

According to the present invention, there is provided a program being executable by a computer,

the computer being used together with a terminal being connectable to a first network, and a VPN server for connecting the terminal to the first network by virtual private network (VPN) connection,

the program causing the computer to include:

a function of receiving first address identification information capable of identifying a first address being an address allocated to the terminal in the first network, and correlating and storing, in a storage, the received first address identification information with terminal authentication information that authenticates the terminal; and

a function of reading out, upon receiving the terminal authentication information from the VPN server, the first address identification information associated with the terminal authentication information from the storage, and transmitting the first address being identified by the first address identification information, to the VPN server.

### Advantageous Effects of Invention

According to the present invention, even when a destination of connection of a terminal is switched from a first network to VPN connection, an address of the terminal is unchanged.

### BRIEF DESCRIPTION OF DRAWINGS

The above-described object, other objects, features and advantageous effects will become clearer by preferred example embodiments to be described below, and the following accompanying drawings.

FIG. 1 is a diagram for describing a configuration of a communication management system according to an example embodiment.

FIG. 2 is a diagram illustrating an example of a functional configuration of a management server.

FIG. 3 is a diagram illustrating an example of a functional configuration of a VPN server.

FIG. 4 is a diagram illustrating an example of a functional configuration of a terminal.

FIG. 5 is a diagram illustrating an example of a hardware configuration of the management server.

FIG. 6 is a flowchart for describing a first example of an operation of the management server at a time when the terminal directly connects to a first network.

FIG. 7 is a diagram illustrating a modification of FIG. 6.

FIG. 8 is a flowchart for describing a first example of operations of respective apparatuses at a time when the terminal connects to the first network via a second network by VPN connection.

FIG. 9 is a flowchart for describing a second example of the operations of the respective apparatuses at a time when the terminal connects to the first network via the second network by VPN connection.

FIG. 10 is a flowchart for describing a third example of the operations of the respective apparatuses at a time when the terminal connects to the first network via the second network by VPN connection.

### EXAMPLE EMBODIMENT

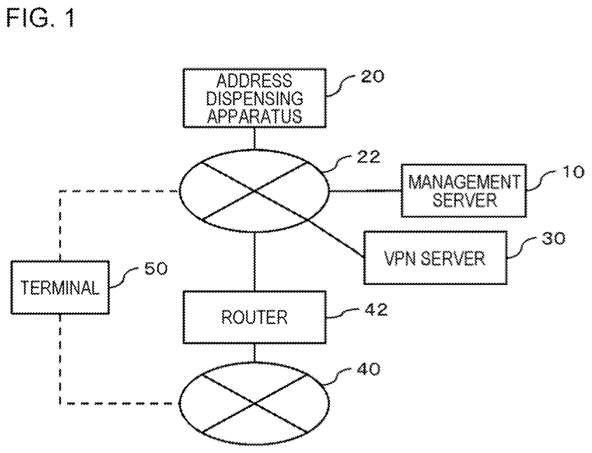

FIG. 1 is a diagram for describing a configuration of a communication management system according to an example embodiment. The communication management system is used together with a terminal 50, and includes a management server 10 and a VPN server 30. The terminal 50 is connectable to a first network 22 (e.g., a home network), and is also connectable to a second network 40. The VPN server 30 is used when connecting the terminal 50, which is connected to the second network 40, to the first network 22 by VPN (Virtual Private Network) connection. Note that a router 42 having a VPN function is provided between the second network 40 and the first network 22. The second network 40 includes, for example, a public communication network. At least a part of the public communication network is a wireless communication network.

The first network 22 is provided with an address dispensing apparatus 20. The address dispensing apparatus 20 is a server for address dispensing, such as a DHCP server, and allocates an address (e.g., IP address), which is used in the first network 22, to the terminal 50 which has connected to the first network 22. Hereinafter, the address allocated to the terminal 50 is described as “first address”. The address dispensing apparatus 20 dispenses the first address by correlating the first address with terminal identification information which identifies the terminal 50, and stores in a storage unit a correspondence relation between the first address and the terminal identification information. The storage unit may be built in the address dispensing apparatus 20, or may be disposed outside the address dispensing apparatus 20. The terminal identification information is, for example, a MAC address or International Mobile Subscriber Identity (IMSI).

In addition, the management server 10 and the VPN server 30 make an address, which is allocated to the terminal 50 in the first network when VPN connection has been established, identical to the first address. Hereinafter, the functions of the management server 10 and the VPN server 30 will be described in detail.

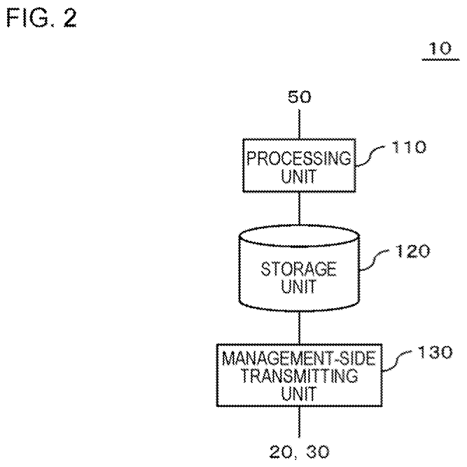

FIG. 2 is a diagram illustrating an example of a functional configuration of the management server 10. The management server 10 includes a processing unit 110, a storage unit 120 and a management-side transmitting unit 130. Note that the storage unit 120 may be provided outside 10.

The processing unit 110 receives information capable of identifying the first address allocated to the terminal 50 (hereinafter referred to as “first address identification information”). The first address identification information is, for example, the above-described terminal identification information, but may be the first address itself. The transmission source of the first address identification information is, for example, the terminal 50, but may be some other apparatus (e.g., address dispensing apparatus 20). In addition, the processing unit 110 generates information for authenticating the terminal 50 (hereinafter referred to as “terminal authentication information”) to the terminal 50, and correlates, and stores in the storage unit 120, the terminal authentication information and the first address identification information. The terminal authentication information is, for example, a combination of an ID and a password, but is not limited to this.

The processing unit 110 transmits the terminal authentication information to the terminal 50. When connecting to the first network via the second network 40 by VPN connection, the terminal 50 transmits the terminal authentication information to the VPN server 30 via the router 42. The VPN server 30 transmits the terminal authentication information received from the terminal 50 to the management server 10.

Upon receiving the terminal authentication information from the VPN server 30, the management-side transmitting unit 130 reads out first address identification information associated with the terminal authentication information from the storage unit 120, and transmits a first address, which is identified by the first address identification information, to the VPN server 30. For example, the management-side transmitting unit 130 receives the first address associated with the first address identification information from the address dispensing apparatus 20, and transmits the first address to the VPN server 30.

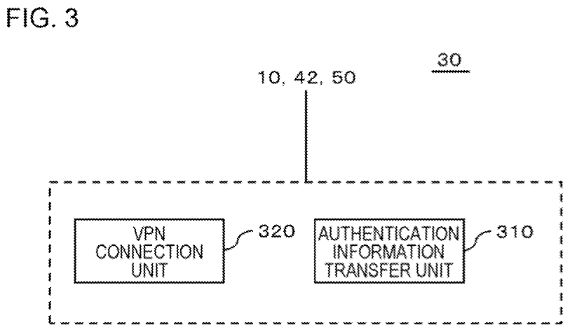

FIG. 3 is a diagram illustrating an example of a functional configuration of the VPN server 30. The VPN server 30 includes an authentication information transfer unit 310 and a VPN connection unit 320. Upon receiving the terminal authentication information from the terminal 50, the authentication information transfer unit 310 transmits the terminal authentication information to the management server 10. The VPN connection unit 320 connects the terminal 50 to the first network by VPN connection by using an address identical to the first address transmitted from the management server 10.

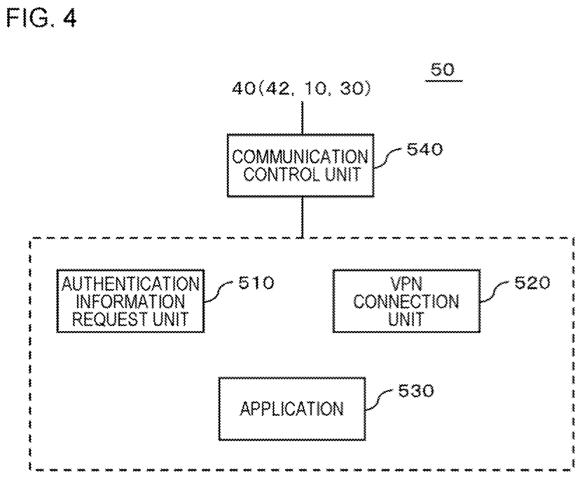

FIG. 4 is a diagram illustrating an example of a functional configuration of the terminal 50. The terminal 50 includes an authentication information request unit 510, a VPN connection unit 520, an application 530, and a communication control unit 540. The authentication information request unit 510 transmits an issuance request for terminal authentication information to the management server 10 when a connection to the first network 22 is established and the first address is allocated from the address dispensing apparatus 20. The VPN connection unit 520 causes the terminal 50 to function as a client of the VPN. The application 530 is an application used in the terminal 50, and the kind of the application is various. The communication control unit 540 executes various controls when connecting the terminal 50 to the network. An example of the controls is a start and end of the VPN connection unit 520.

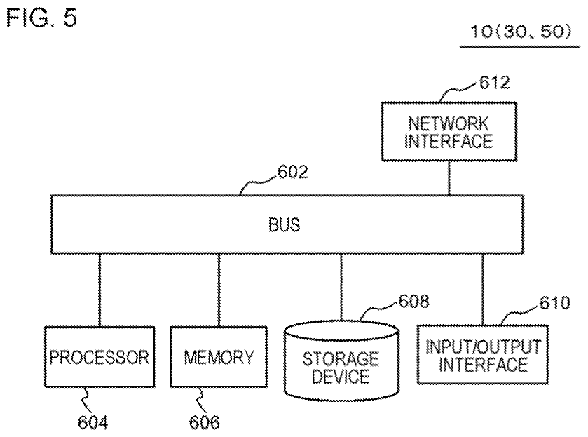

FIG. 5 is a diagram illustrating an example of a hardware configuration of the management server 10. The main configuration of the management server 10 is realized by using an integrated circuit. The integrated circuit includes a bus 602, a processor 604, a memory 606, a storage device 608, an input/output interface 610, and a network interface 612. The bus 602 is a data transmission path for mutual data transmission and reception among the processor 604, memory 606, storage device 608, input/output interface 610 and network interface 612. However, the method of interconnecting the processor 604 and the like is not limited to the bus connection. The processor 604 is an arithmetic processing apparatus which is realized by using a microprocessor or the like. The memory 606 is a memory which is realized by using a random access memory (RAM) or the like. The storage device 608 is a storage device which is realized by using a read only memory (ROM), a flash memory, or the like.

The input/output interface 610 is an interface for connecting the management server 10 and peripheral devices.

The network interface 612 is an interface for connecting the management server 10 to a communication network, for example, the first network 22. The method, by which the network interface 612 connects the management server 10 to the communication network, may be a wireless connection or a wired connection.

The storage device 608 stores a program module for realizing respective functional elements of the management server 10. The processor 604 realizes the respective functions of the management server 10 by reading out the program module into the memory 606 and executing the program module. In addition, the storage device 608 functions also as the storage unit 120.

Note that the hardware configuration of each of the VPN server 30 and the terminal 50 is similar to the hardware configuration of 10.

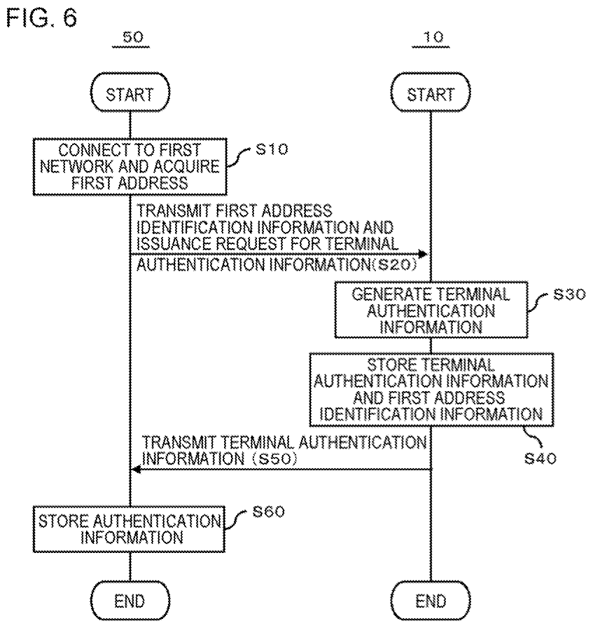

FIG. 6 is a flowchart for describing a first example of an operation of the management server 10 at a time when the terminal 50 directly connects to the first network 22. To begin with, when connecting to the first network 22, a first address is dispensed to the terminal 50 from the address dispensing apparatus 20. At this time, terminal identification information, such as a MAC address or IMSI, is handled as first address identification information. Then, the address dispensing apparatus 20 correlates and stores the first address, which is dispensed to the terminal 50, and the terminal identification information of the terminal 50. The communication control unit 540 of the terminal 50 acquires the first address (step S10).

Next, the communication control unit 540 transmits an issuance request for terminal authentication information to the management server 10. At this time, the terminal 50 transmits the first address identification information, i.e., the terminal identification information, to the management server 10 (step S20). Note that the transmission of the first address identification information may mean the issuance request for terminal authentication information.

The processor 110 of the management server 10 generates terminal authentication information of the terminal 50 (step S30), and correlates, and stores in the storage unit 120, the generated terminal authentication information and the first address identification information (step S40). Then, the processing unit 110 transmits the generated terminal authentication information to the terminal 50 (step S50). The VPN connection unit 520 of the terminal 50 stores the received terminal authentication information (step S60).

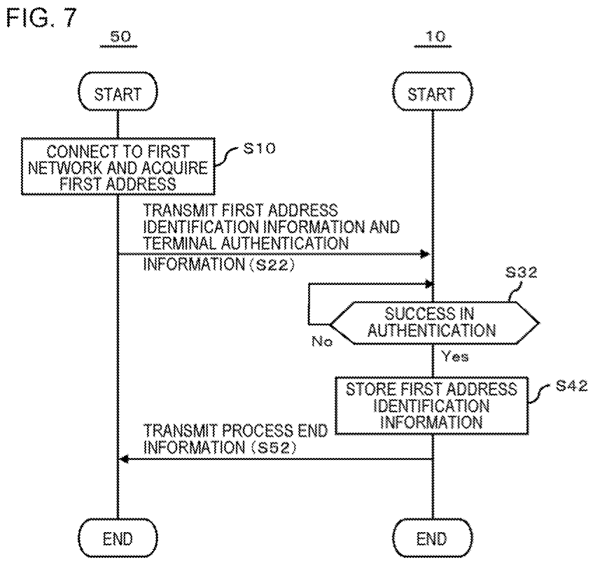

FIG. 7 is a diagram illustrating a modification of FIG. 6, i.e., a second example of the operation of the management server 10 at a time when the terminal 50 directly connects to the first network 22. Before the process illustrated in FIG. 7, the terminal 50 connects to the management server 10 in advance, and the management server 10 transmits terminal authentication information to the terminal 50 in advance. In addition, the terminal 50 stores the terminal authentication information in advance. Alternatively, the management server 10 may generate terminal authentication information for the terminal 50 in advance, and may deliver the terminal authentication information to the user of the terminal 50 by some means, and the user may input the terminal authentication information to the terminal 50 and may store the terminal authentication information in the terminal 50.

Like the example illustrated in FIG. 6, when connecting to the first network 22, the first address is dispensed to the terminal 50 from the address dispensing apparatus 20. In addition, the address dispensing apparatus 20 correlates and stores the first address, which is dispensed to the terminal 50, and the terminal identification information of the terminal 50. The communication control unit 540 of the terminal 50 acquires the first address (step S10). Then, the communication control unit 540 correlates the terminal authentication information with the first address identification information, and transmits the correlated terminal authentication information and first address identification information to the management server 10 (step S22).

The processing unit 110 of the management server 10 executes authentication of the terminal 50 by using the terminal authentication information which is transmitted from the terminal 50 (step S32). If the authentication is successful (step S32: Yes), the processing unit 110 correlates and stores the first address identification information, which is transmitted from the terminal 50, and the terminal authentication information (step S42). Then, the processing unit 110 transmits to the terminal 50 information (process end information) indicating that the process has been normally terminated (step S52).

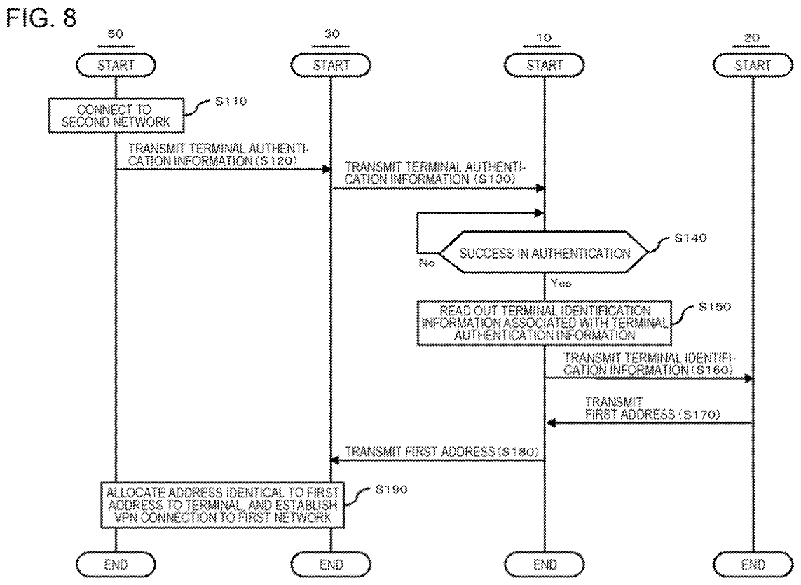

FIG. 8 is a flowchart for describing a first example of operations of respective apparatuses at a time when the terminal 50 connects to the first network 22 via the second network 40 by VPN connection. This process corresponds to a case where the storage unit 120 of the management server 10 correlates and stores the terminal identification information and the terminal authentication information.

Before the process illustrated in FIG. 8, the terminal 50 directly connects to the first network 22, and operates the application. When the communication control unit 540 of the terminal 50 detects that the terminal 50 has moved into the range of communication of the second network 40, while continuing the operation of the application, the communication control unit 540 connects to the second network 40 (step S110), and transmits the terminal authentication information, together with a VPN connection request, to the VPN server 30 via the second network 40 and the router 42 (step S120). Note that the state of being outside the range of communication of the first network 22 may be added as a condition for executing the process illustrated in step S110.

Upon receiving the terminal authentication information from the terminal 50, the authentication information transfer unit 310 of the VPN server 30 transmits the terminal authentication information to the management server 10 (step S130).

Upon receiving the terminal authentication information from the VPN server 30, the management-side transmitting unit 130 of the management server 10 executes an authentication process for the terminal authentication information (step S140). If the authentication is successful (step S140: Yes), the management-side transmitting unit 130 reads out the terminal identification information associated with the terminal authentication information from the storage unit 120 (step S150), and transmits the read-out terminal identification information to the address dispensing apparatus 20 (inquiry process: step S160).

The address dispensing apparatus 20 reads out the first address, which corresponds to the terminal identification information transmitted from the management server 10, from the storage unit, and transmits the read-out first address to the management server 10 (step S170). The management-side transmitting unit 130 of the management server 10 transmits the first address, which is received from the address dispensing apparatus 20, to the VPN server 30 (step S180). The VPN connection unit 320 of the VPN server 30 connects the terminal 50 to the first network 22 by VPN connection, by using an address identical to the first address received from the management server 10 (step S190).

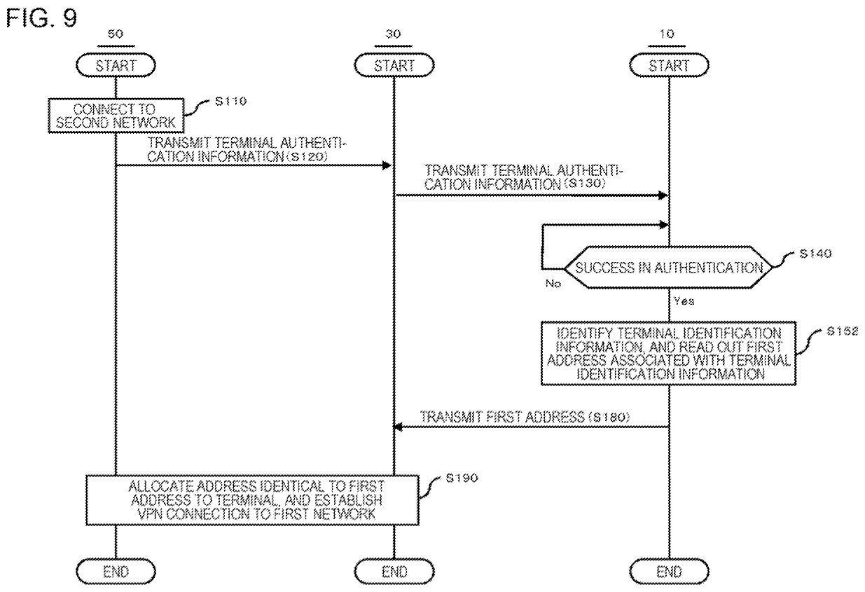

FIG. 9 is a flowchart for describing a second example of the operations of the respective apparatuses at a time when the terminal 50 connects to the first network 22 via the second network 40 by VPN connection. This process corresponds to a case where the storage unit 120 of the management server 10 correlates and stores the first address and the terminal authentication information.

The process from step S110 to step S140 is similar to the process in the example illustrated in FIG. 8. If the authentication of the terminal authentication information is successful (step S140: Yes), the management-side transmitting unit 130 reads out the first address associated with the terminal authentication information from the storage unit 120 (step S152), and transmits the read-out terminal identification information to the VPN server 30 (step S180). The subsequent process (step S190) is as described with reference to FIG. 8.

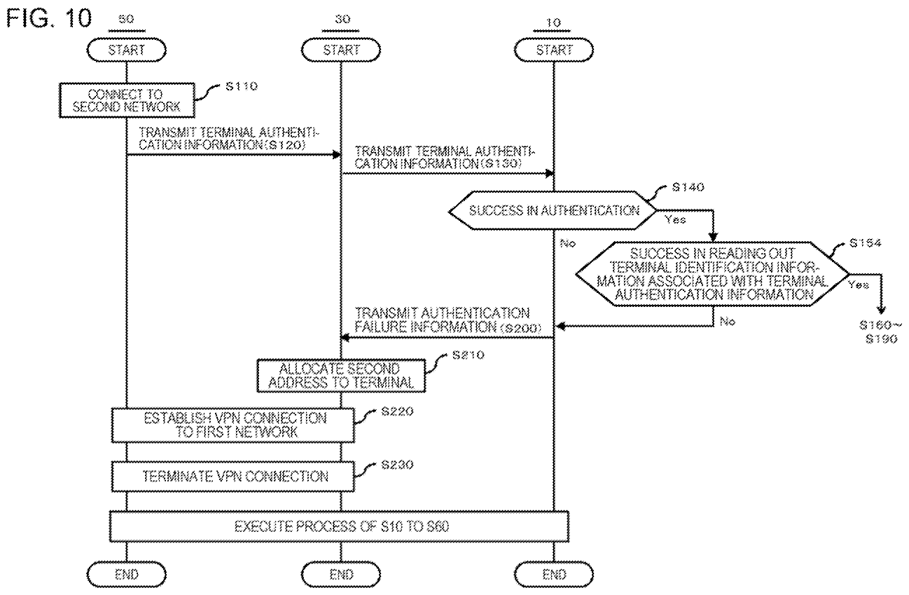

FIG. 10 is a flowchart for describing a third example of the operations of the respective apparatuses at a time when the terminal 50 connects to the first network 22 via the second network 40 by VPN connection. In the process illustrated in FIG. 10, the terminal 50 connects to the management server 10 in advance, and the management server 10 transmits terminal authentication information to the terminal 50 in advance. In addition, the terminal 50 prestores the terminal authentication information. Thus, when the terminal 50 directly connects to the first network 22, the process illustrated in FIG. 7 is executed.

To begin with, the process from step S110 to step S140 is similar to the process in the example illustrated in FIG. 8. Then, if the authentication is successful in step S140 (Yes) and the read-out of the terminal identification information associated with the terminal authentication information is successful (step S154: Yes), the process illustrated in steps S160 to S190 of FIG. 8 is executed.

When the authentication failed, i.e., when the terminal 50 never connected to the first network 22 (step S140: No), and when the read-out of the terminal identification information associated with the terminal authentication information failed (step S154: No), the management-side transmitting unit 130 of the management server 10 transmits to the VPN server 30 information (authentication failure information) indicating that the authentication failed (step S200). Upon receiving the authentication failure information, the VPN connection unit 320 of the VPN server 30 selects an address (hereinafter referred to as “second address”), which is allocated to the terminal 50, from among addresses that the VPN connection unit 320 manages, and connects the terminal 50 to the first network 22 by VPN connection by using the second address (step S220).

Thereafter, upon detecting the entering to the range of communication of the first network 22, the communication control unit 540 of the terminal 50 monitors whether the operation of the application using the VPN connection is terminated or not, while continuing the VPN connection. If the operation of the application ends, the communication control unit 540 terminates the VPN connection (step S230).

Subsequently, the communication control unit 540 of the terminal 50 connects to the first network 22. Then, the process described with reference to step S10 to step S60 of FIG. 6 is executed.

As described above, according to the present example embodiment, the terminal 50 establishes the VPN connection when the terminal 50 has moved out of the range of communication of the first network 22 and into the range of communication of the second network 40. At this time, the management server 10 transmits the address (first address), which has been allocated to the terminal 50 in the first network 22, to the VPN server 30. Thus, the VPN server 30 can connect the terminal 50 to the first network 22 by the VPN connection by using the first address. Accordingly, the terminal 50 can connect to the first network 22 by using the identical address (first address) even when the direct connection to the first network 22 is switched to the connection (VPN connection) via the VPN. Therefore, the possibility of interruption of communication at the time of switching can be lowered.

Note that in the above-described embodiment, when the terminal 50 has moved in the first network 22, or has moved between the first network 22 and the second network 40, while holding the first address or the second address, the terminal 50 may send Gratuitous ARP (RFC5227) directly or via the VPN connection. By doing so, an arp cache or L3 table in the first network 22 is updated, and, as a result, a communication packet for the terminal 50 reaches the terminal 50 within the first network 22.

Hereinafter, examples of reference modes will be supplementally noted.

1. A communication management system being used together with a terminal being connectable to a first network, the communication management system including:

a VPN server for connecting the terminal to the first network by virtual private network (VPN) connection; and

a management server,

the management server including:

a processing unit that receives first address identification information capable of identifying a first address being an address allocated to the terminal in the first network, and correlates and stores, in storage, the received first address identification information with terminal authentication information that authenticates the terminal; and

a management-side transmitting unit that reads out, upon receiving the terminal authentication information from the VPN server, the first address identification information associated with the terminal authentication information from the storage, and transmits the first address being identified by the first address identification information, to the VPN server,

the VPN server including:

an authentication information transfer unit transmits the terminal authentication information of the terminal that requests the VPN connection, to the management server; and

a VPN connection unit that connects the terminal to the first network by the VPN connection by using an address identical to the first address transmitted from the management server.

2. The communication management system according to the above 1, wherein

an address dispensing server that dispenses an address in the first network, correlates and stores the first address with first terminal identification information that identifies the terminal,

the first address identification information is the terminal identification information, and

the management-side transmitting unit of the management server sends an inquiry about the first address associated with the first terminal identification information to the address dispensing server, and transmits the first address received from the address dispensing server, to the VPN server.

3. The communication management system according to the above 2, wherein

the management-side transmitting unit of the management server transmits second terminal identification information being different from the first terminal identification information, to the address dispensing server, and causes the address dispensing server to correlate and store the second terminal identification information with the first address.

4. The communication management system according to the above 1, wherein

the first address identification information is the first address.

5. The communication management system according to any one of the above 1 to 4, wherein

the management-side transmitting unit of the management server transmits, when the first address associated with the terminal authentication information is absent, address absence information indicating to that effect to the VPN server, and

the VPN connection unit of the VPN server connects, upon receiving the address absence information, the terminal to the first network by the VPN connection by using an address coincidence of which with the first address is not ensured.

6. The communication management system according to the above 5, further including the terminal, wherein,

in the terminal, a specific application is being in the VPN connection, and

the terminal includes a communication control unit that terminates the VPN connection and directly connects to the first network, after the terminal becomes also connectable to the first network and an operation of the specific application is stopped.

7. A VPN server being used together with a terminal being connectable to a first network, and a management server, the VPN server being configured to connect the terminal to the first network by virtual private network (VPN) connection, the VPN server including:

an authentication information transfer unit transmits terminal authentication information of the terminal that requests the VPN connection, to the management server; and

a VPN connection unit that connects the terminal to the first network by the VPN connection by using an address identical to the first address transmitted from the management server.

8. A management server being used together with a terminal being connectable to a first network, and a VPN server for connecting the terminal to the first network by virtual private network (VPN) connection, the management server including:

a processing unit that receives first address identification information capable of identifying a first address being an address allocated to the terminal in the first network, and correlates and stores, in a storage, the received first address identification information with terminal authentication information that authenticates the terminal; and

a management-side transmitting unit that reads out, upon receiving the terminal authentication information from the VPN server, the first address identification information associated with the terminal authentication information from the storage, and transmits the first address being identified by the first address identification information, to the VPN server.

9. A terminal being connectable to a first network and connectable to the first network by a VPN server by virtual private network (VPN) connection, wherein,

in the terminal, a specific application is being in the VPN connection, and

the terminal includes a communication control unit that terminates the VPN connection and directly connects to the first network, after the terminal becomes also connectable to the first network and an operation of the specific application is stopped.

10. A communication management method using a VPN server and a management server, wherein

the VPN server and the management server are used together with a terminal being connectable to a first network,

the VPN server is configured to connect the terminal to the first network by virtual private network (VPN) connection,

the management server is configured to:

receive first address identification information capable of identifying a first address being an address allocated to the terminal in the first network, and correlate and store, in a storage, the received first address identification information with terminal authentication information that authenticates the terminal; and

read out, upon receiving the terminal authentication information from the VPN server, the first address identification information associated with the terminal authentication information from the storage, and transmit the first address being identified by the first address identification information, to the VPN server, and

the VPN server is configured to:

transmit the terminal authentication information of the terminal that requests the VPN connection, to the management server; and

connect the terminal to the first network by the VPN connection by using an address identical to the first address transmitted from the management server.

11. The communication management method according to the above 10, wherein

an address dispensing server that dispenses an address in the first network, correlates and stores the first address with first terminal identification information that identifies the terminal,

the first address identification information is the terminal identification information, and

the management server sends an inquiry about the first address associated with the first terminal identification information to the address dispensing server, and transmits the first address received from the address dispensing server, to the VPN server.

12. The communication management method according to the above 11, wherein

the management server transmits second terminal identification information being different from the first terminal identification information, to the address dispensing server, and causes the address dispensing server to correlate and store the second terminal identification information with the first address.

13. The communication management method according to the above 11, wherein

the first address identification information is the first address.

14. The communication management method according to any one of the above 10 to 13, wherein

the management server transmits, when the first address associated with the terminal authentication information is absent, address absence information indicating to that effect to the VPN server, and

the VPN server connects, upon receiving the address absence information, the terminal to the first network by the VPN connection by using an address coincidence of which with the first address is not ensured.

15. The communication management method according to the above 14, further including the terminal, wherein,

in the terminal, a specific application is being in the VPN connection, and

the terminal includes a communication control unit that terminates the VPN connection and directly connects to the first network, after the terminal becomes also connectable to the first network and an operation of the specific application is stopped.

16. A communication management method using a computer,

the computer being configured to:

function as a VPN server being used together with a terminal being connectable to a first network, and a management server, the VPN server being configured to connect the terminal to the first network by virtual private network (VPN) connection;

transmit terminal authentication information of the terminal that requests the VPN connection, to the management server; and

connect the terminal to the first network by the VPN connection by using an address identical to a first address transmitted from the management server.

17. A communication management method using a computer,

the computer being used together with a terminal being connectable to a first network, and a VPN server for connecting the terminal to the first network by virtual private network (VPN) connection, and

the computer being configured to:

receive first address identification information capable of identifying a first address being an address allocated to the terminal in the first network, and correlate and store, in a storage, the received first address identification information with terminal authentication information that authenticates the terminal; and

read out, upon receiving the terminal authentication information from the VPN server, the first address identification information associated with the terminal authentication information from the storage, and transmit the first address being identified by the first address identification information, to the VPN server.

18. A program being executable by a computer,

the program causing the computer to

function as a VPN server being used together with a terminal being connectable to a first network, and a management server, the VPN server being configured to connect the terminal to the first network by virtual private network (VPN) connection,

the program causing the computer to include:

a function of transmitting terminal authentication information of the terminal that requests the VPN connection, to the management server; and

a function of connecting the terminal to the first network by the VPN connection by using an address identical to a first address transmitted from the management server.

19. A program being executable by a computer,

the computer being used together with a terminal being connectable to a first network, and a VPN server for connecting the terminal to the first network by virtual private network (VPN) connection,

the program causing the computer to include:

a function of receiving first address identification information capable of identifying a first address being an address allocated to the terminal in the first network, and correlating and storing, in a storage, the received first address identification information with terminal authentication information that authenticates the terminal; and

a function of reading out, upon receiving the terminal authentication information from the VPN server, the first address identification information associated with the terminal authentication information from the storage, and transmitting the first address being identified by the first address identification information, to the VPN server.

The present application claims priority based on Japanese Patent Application No. 2019-008312, filed on Jan. 22, 2019; the entire contents of which are incorporated herein by reference.

What is claimed is:

1. A communication management system being used together with a terminal being connectable to a first network, the communication management system comprising:
a VPN server for connecting the terminal to the first network by virtual private network (VPN) connection; and
a management server,
the management server including:
a processing unit that receives first address identification information capable of identifying a first address being an address allocated to the terminal in the first network, and correlates and stores, in a storage, the received first address identification information with terminal authentication information that authenticates the terminal; and
a management-side transmitting unit that reads out, upon receiving the terminal authentication information from the VPN server, the first address identification information associated with the terminal authentication information from the storage, and transmits the first address being identified by the first address identification information, to the VPN server,
the VPN server including:
an authentication information transfer unit that transmits the terminal authentication information of the terminal that requests the VPN connection, to the management server; and
a VPN connection unit that connects the terminal to the first network by the VPN connection by using an address identical to the first address transmitted from the management server.

2. The communication management system according to claim 1, wherein
an address dispensing server that dispenses an address in the first network, correlates and stores the first address with first terminal identification information that identifies the terminal,
the first address identification information is the first terminal identification information, and
the management-side transmitting unit of the management server sends an inquiry about the first address associated with the first terminal identification information to the address dispensing server, and transmits the first address received from the address dispensing server, to the VPN server.

3. The communication management system according to claim 2, wherein
the management-side transmitting unit of the management server transmits second terminal identification information being different from the first terminal identification information, to the address dispensing server, and causes the address dispensing server to correlate and store the second terminal identification information with the first address.

4. The communication management system according to claim 1, wherein
the first address identification information is the first address.

5. The communication management system according to claim 1, wherein
the management-side transmitting unit of the management server transmits, when the first address associated with the terminal authentication information is absent, address absence information indicating to that effect to the VPN server, and
the VPN connection unit of the VPN server connects, upon receiving the address absence information, the terminal to the first network by the VPN connection by using a second address.

6. The communication management system according to claim 5, further comprising the terminal, wherein,
in the terminal, a specific application is being in the VPN connection, and
the terminal includes a communication control unit that terminates the VPN connection and directly connects to the first network, after the terminal becomes also connectable to the first network and an operation of the specific application is stopped.

7. (canceled)

8. A management server being used together with a terminal being connectable to a first network, and a VPN server for connecting the terminal to the first network by virtual private network (VPN) connection, the management server comprising:
a processing unit that receives first address identification information capable of identifying a first address being an address allocated to the terminal in the first network, and correlates and stores, in a storage, the received first address identification information with terminal authentication information that authenticates the terminal; and
a management-side transmitting unit that reads out, upon receiving the terminal authentication information from the VPN server, the first address identification information associated with the terminal authentication information from the storage, and transmits the first address being identified by the first address identification information, to the VPN server.

9. A terminal being connectable to a first network and connectable to the first network by a VPN server by virtual private network (VPN) connection, wherein,
in the terminal, a specific application is being in the VPN connection, and
the terminal includes a communication control unit that terminates the VPN connection and directly connects to the first network, after the terminal becomes also connectable to the first network and an operation of the specific application is stopped.

10.-19. (canceled)
